(19) United States
(12) Patent Application Publication
(10) Pub. No.: US 2021/0091348 A1
(43) Pub. Date: Mar. 25, 2021

(54) METHOD OF CONNECTING CELLS IN A BATTERY ARRAY

(71) Applicant: Ford Global Technologies, LLC, Dearborn, MI (US)

(72) Inventors: Abdul Lateef, Canton, MI (US); Daniel Roberts, Livonia, MI (US); Francisco Fernandez-Galindo, Canton, MI (US)

(21) Appl. No.: 16/581,994

(22) Filed: Sep. 25, 2019

(51) Int. Cl. H01M 2/10; H01M 2/20; H01M 2/22; H01M 10/04; H01M 10/48

(52) U.S. Cl. CPC H01M 2/1077; H01M 2/206; H01M 2220/20; H01M 10/0404; H01M 10/482; H01M 2/22

(57) ABSTRACT

A method and apparatus includes, among other things, a plurality of battery cells laid next to each other such that cell tabs from one battery cell overlap cell tabs from an adjacent battery cell to form a set of overlapped cell tabs. Each set of overlapped cell tabs are directly joined to each other at a connection interface. A voltage sense circuitry is directly attached to the cell tabs.

### TECHNICAL FIELD

This disclosure relates generally to a method of connecting cells in a battery array for an electrified vehicle.

### BACKGROUND

Current array configurations utilize an Interconnect Board Assembly (ICB) to facilitate cell-to-cell attachment using copper busbars. The ICB is a plastic and metal component that is welded to the cell terminals during array assembly. The plastic component of the ICB is used to hold the busbars in position prior to installation in the array. Once the cells are welded to the ICB assembly, the function of the busbars is to provide an electrical path from the cells to the electrified vehicle components.

### SUMMARY

A method according to an exemplary aspect of the present disclosure includes, among other things, (a) laying battery cells next to each other such that at least one cell tab from one battery cell overlaps at least one cell tab from an adjacent battery cell; (b) joining overlapping cell tabs directly to each other; (c) placing the battery cells in a final assembly position; and (d) installing voltage sense circuitry directly to the cell tabs.

In a further non-limiting embodiment of the foregoing method, step (c) includes folding the battery cells.

In a further non-limiting embodiment of any of the foregoing methods, the one battery cell has a first cell tab comprising an aluminum material and the adjacent battery cell has a second cell tab comprising a copper material, and the method includes placing the first cell tab over the second cell tab such that the first cell tab directly faces a laser weld tool.

In a further non-limiting embodiment of any of the foregoing methods, step (b) includes one of the following joining methods: ultrasonic welding, laser welding, fastening, riveting, or adhering.

In a further non-limiting embodiment of any of the foregoing methods, the battery cells include at least one first battery cell and at least one second battery cell, and the method includes laying the at least one second battery cell next to the at least one first battery cell such that the cell tabs of the at least one first and second cells overlap each other.

In a further non-limiting embodiment of any of the foregoing methods, the at least one first battery cell comprises a plurality of first battery cells stacked on top of each other to form a first cell stack, and wherein the at least one second battery cell comprises a plurality of second battery cells stacked on top of each other to form a second cell stack, and the method includes laying the second cell stack next to the first cell stack such that the cell tabs of the first and second cell stacks overlap each other.

In a further non-limiting embodiment of any of the foregoing methods, the method includes (e) installing the battery cells into an array, and (f) connecting a cable to cell terminals of the battery cells to connect the array to a pack wiring harness or sensor module.

In a further non-limiting embodiment of any of the foregoing methods, step (d) includes directly connecting the voltage sense circuitry to the cell tabs using ultrasonic welding.

In a further non-limiting embodiment of any of the foregoing methods, step (d) includes directly connecting the voltage sense circuitry to the cell tabs using electrically conductive rivets.

A method, according to yet another exemplary aspect of the present disclosure includes, among other things, (a) laying battery cells next to each other such that at least one cell tab from one battery cell overlaps at least one cell tab from an adjacent battery cell; (b) joining overlapping cell tabs directly to each other; (c) folding the battery cells in a final assembly position; and (d) installing a voltage sense circuitry directly to the cell tabs.

In a further non-limiting embodiment of any of the foregoing methods, step (b) includes laser welding, ultrasonic welding, fastening, riveting, or adhering the cell tabs to each other.

In a further non-limiting embodiment of any of the foregoing methods, the battery cells include at least one first battery cell and at least one second battery cell, and the method includes laying the at least one second battery cell next to the at least one first battery cell such that the cell tabs of the at least one first and second cells overlap each other.

In a further non-limiting embodiment of any of the foregoing methods, wherein the at least one first battery cell comprises a plurality of first battery cells stacked on top of each other to form a first cell stack, and wherein the at least one second battery cell comprises a plurality of second battery cells stacked on top of each other to form a second cell stack, and the method includes laying the second cell stack next to the first cell stack such that the cell tabs of the first and second cell stacks overlap each other.

In a further non-limiting embodiment of any of the foregoing methods, the method includes (e) installing the battery cells into an array, and (f) connecting a cable to cell terminals of the battery cells to connect the array to a pack wiring harness or sensor module.

In a further non-limiting embodiment of any of the foregoing methods, step (d) includes directly connecting the voltage sense circuitry to the cell tabs using ultrasonic welding.

In a further non-limiting embodiment of any of the foregoing methods, step (d) includes directly connecting voltage sense circuitry to the cell tabs using electrically conductive rivets.

An apparatus according to still another exemplary aspect of the present disclosure includes, among other things, a plurality of battery cells laid next to each other such that cell tabs from one battery cell overlap cell tabs from an adjacent battery cell to form a set of overlapped cell tabs. Each set of overlapped cell tabs are directly joined to each other at a connection interface. A voltage sense circuitry is directly attached to the cell tabs.

In a further non-limiting embodiment of the foregoing apparatus, the battery cells include at least one first battery cell and at least one second battery cell, and wherein the at least one second battery cell is laid next to the at least one first battery cell such that the cell tabs of the at least one first and second cells overlap each other prior to joining the cell tabs to each other.

In a further non-limiting embodiment of any of the foregoing apparatus, the at least one first battery cell comprises a plurality of first battery cells stacked on top of each other to form a first cell stack, and wherein the at least one second battery cell comprises a plurality of second battery cells stacked on top of each other to form a second cell stack, and wherein the second cell stack is laid next to the first cell stack such that the cell tabs of the first and second cell stacks overlap each other prior to joining the cell tabs to each other.

In a further non-limiting embodiment of any of the foregoing apparatus, the battery cells are positioned within an array, and including a cable connected to cell terminals of the battery cells to connect the array to a pack wiring harness or sensor module.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1A illustrates one battery cell laid next to another battery cell.

FIG. 1B is similar to FIG. 1A but shows stacks of battery cells laid next to each other

FIG. 2A schematically illustrates using ultrasonic welding to connect overlapping cell tabs of FIG. 1A directly to each other.

FIG. 2B schematically illustrates using ultrasonic welding to connect overlapping cell tabs of FIG. 1B directly to each other.

FIG. 3A shows a cell-to-cell connection after the battery cells have been laser welded and folded for the configuration of FIG. 1A.

FIG. 3B shows a cell-to-cell connection after the battery cells have been laser welded and folded for the configuration of FIG. 1B.

FIG. 4 is a flow chart of one example assembly method for the configurations of FIGS. 1A and 1B.

FIG. 5 schematically illustrates a folding process for the configuration of FIG. 1B.

FIG. 6 is the final assembly configuration for the cells of FIG. 5.

### DETAILED DESCRIPTION

This disclosure details a method of connecting cells in a battery array for an electrified vehicle. FIG. 1A shows a plurality of battery cells 10 that each have a first end portion 12 and an opposite second end portion 14. One or more cell tabs 16 are located at the first 12 and second 14 end portions. Each battery cell 10 has a positive cell tab (+) and a negative (−) cell tab as shown in FIG. 1. For example, a first battery cell 10a includes at least one first cell tab 16a at the first end portion 12 and at least one second cell tab 16b at the second end portion 14. A first adjacent battery cell 10b includes a third cell tab 16c at the second end portion 14 and a second adjacent battery cell 10c includes a fourth cell tab 16d at the first end portion 12.

A method of connecting the first 10b and second 10c adjacent battery cells to the first battery cell 10a includes the following steps. The battery cells 10a, 10b, 10c are laid out next to each other such that the cell tabs 16a, 16b from the first battery cell 10a overlap the respective cell tabs 16c, 16d from the adjacent battery cells 10b, 10c. Thus, the first cell tab 16a at the first end portion 12 of the first battery cell 10a is overlapping with the third cell tab 16c at the second end portion 14 of the first adjacent battery cell 10b, and the second cell tab 16b at the second end portion 14 of the first battery cell 10a is overlapping with the fourth cell tab 16d at the first end portion 12 of the second adjacent battery cell 10c.

FIG. 1A shows an example where the battery cells 10 include single battery cells 10a, 10b, 10c that are laid next to each other such that their respective cell tabs are overlapping. FIG. 1B shows another example where the battery cells 10 comprise a plurality of first battery cells 10a stacked on top of each other to form a first cell stack S1, a plurality of second battery cells 10b stacked on top of each other to form a second cell stack S2, and a plurality of third battery cells 10c stacked on top of each other to form a third cell stack S3. The cell stacks S1, S2, S3 are laid next to each other such that their respective cell tabs overlap each other prior to joining the cell tabs to each other.

Next, for each example configuration of FIGS. 1A-1B, the overlapping cell tabs 16a/16c and 16b/16d are connected to each other by being welded directly to each other. This connection process can be accomplished using laser welding or ultrasonic welding, for example, or by other joining techniques including adhesion, fastening, riveting, bolting, etc., for example. FIGS. 2A-2B shows an example of ultrasonic welding. In one example, a back plate 18 supports an anvil 20 on a first side 22 of the overlapping cell tabs 16a, 16c and a sonotrode 24 with a transducer 26 is positioned on an opposite second side 28 of the overlapping cell tabs 16a, 16c. A power supply 30 converts low-frequency electricity to high-frequency electricity and the transducer 26 changes the high-frequency electricity into high-frequency sound. The sonotrode 24 focuses the ultrasonic vibrations at the overlapping cell tabs 16a, 16c, which are held by the anvil 20, and welds the tabs 16a, 16c together.

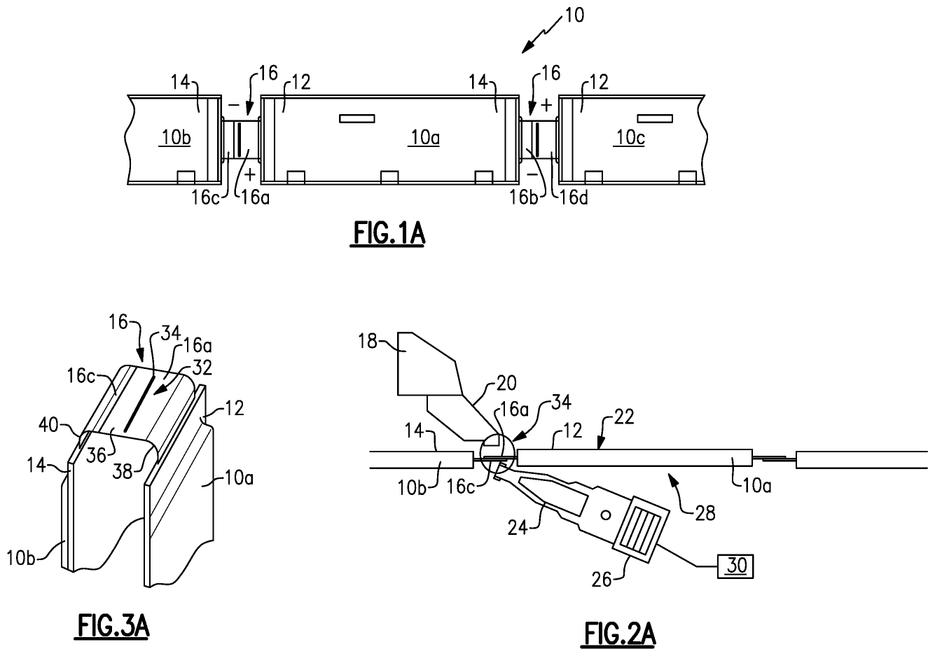

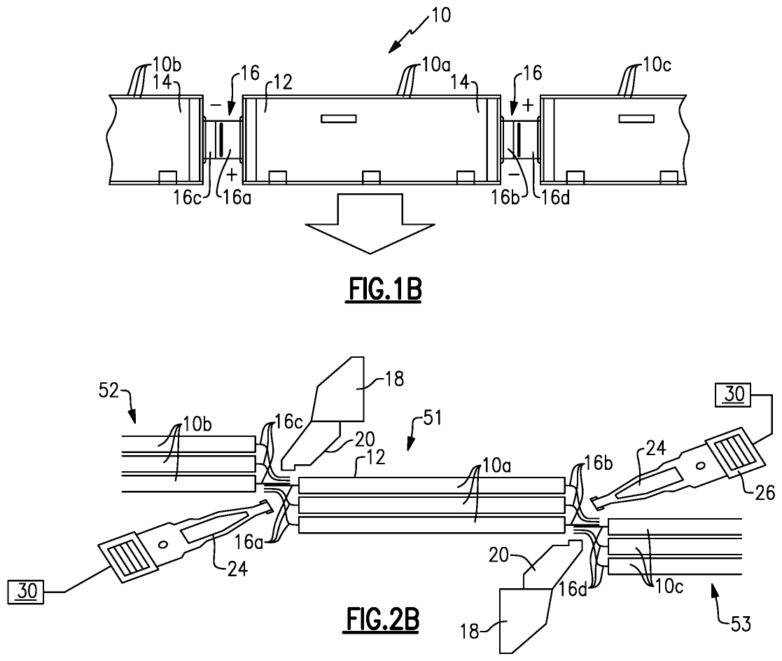

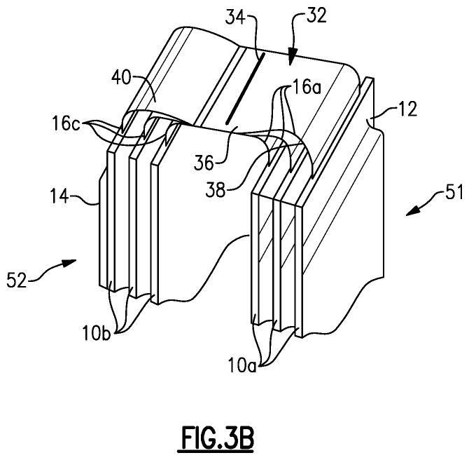

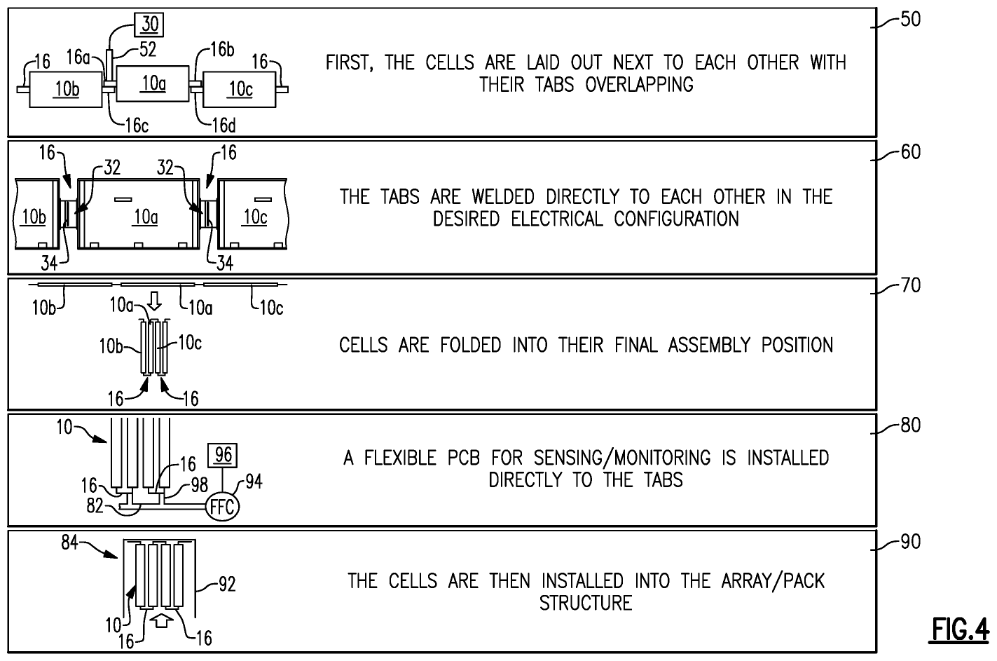

Once all of the overlapping cell tabs 16 have been welded directly together for all of the battery cells 10, the battery cells 10 are then placed into a final assembly position. In one example, the battery cells 10 are folded at a joining area 32 of the overlapping tabs 16 as indicated in FIGS. 3A-B. A weld interface 34 for each joining area 32 is thus provided for the overlapping tabs 16. In the example shown in FIGS. 3A-B, the overlapping tabs 16 have a flat portion 36 where the weld interface 34 is provided, and the first cell tab 16a is folded at a first folding edge 38 at the first end portion 12 of the first battery cell 10. The third cell tab 16c is folded at a second folding edge 40 at the second end portion 14 of the first adjacent battery cell 10b. This prevents folding at the weld interface 34 location.

FIG. 4 shows a flow chart of an example assembly process for each of the example configurations of FIGS. 1A-B. At step 50, the battery cells 10a, 10b, 10c are laid out next to each other such that cell tabs 16a, 16b from the first battery cell 10a overlap the respective cell tabs 16c, 16d from the adjacent battery cells 10b, 10c as described above. In this example, a laser 52 is used to directly connect the cell tabs 16 to each other. In one example, the first cell tab 16a comprises an aluminum material and the first adjacent battery cell 10 has the third cell tab 16c which comprises a copper material. The first cell tab 16a is placed over the third cell tab 16c such that the first cell tab 16a directly faces the laser 52. The power source 30 powers the laser 52 to weld the overlapping tabs directly to each other. By placing the aluminum tab on top, the laser 52 uses less power, which can be advantageous; however, there are other factors that also affect the required weld power. The reverse configuration with copper cell tabs being on top could also be used; however, this configuration would require additional power.

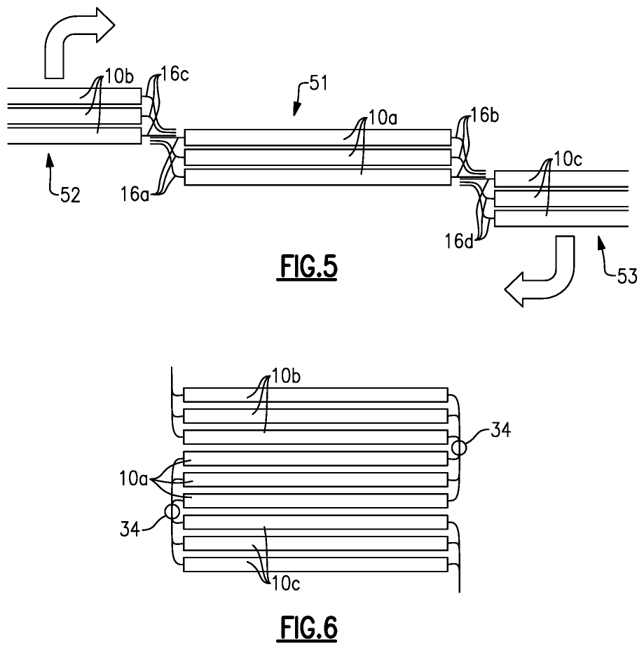

At step 60, the overlapping tabs 16 are welded directly to each other in the desired electrical configuration such that there is a weld interface 34 at each joining area 32. At step 70, the battery cells 10 are then folded in an alternating manner into a final folded assembly position. FIGS. 5 and 6 show the folding process for the first, second, and third cell stacks S1, S2, S3. One weld interface 34 is used to connect the tabs of the first cell stack S1 to the second cell stack S2, and one weld interface 34 is used to connect the tabs of the first cell stack S1 to the third cell stack S3.

At step 80, voltage sense circuitry is installed directly to the cell tabs 16. In one example, the voltage sense circuitry comprises a flexible printed circuit board (PCB) 82 as shown; however, other types of voltage sense circuitry could also be used. The flexible PCB 82 is used for sensing/monitoring cell characteristics as known. The folded battery cells 10 are then installed into an array 84 as shown at step 90. The array 84 comprises an enclosure or housing 92 that protects the battery cells 10.

In one example, a flat flexible cable (FFC) 94 is connected to the flexible PCB 82 to connect the array 84 to an additional electrical component 96 such as a wiring harness or sensor module, for example. The step of directly connecting the flexible PCB 82 to the cell tabs 16 can be done by using ultrasonic welding or electrically conductive rivets as indicated at 98 in FIG. 4.

Current array configurations utilize the separate ICB assembly to facilitate cell-to-cell attachment using copper busbars. By joining the cell tabs directly to each other, there is a significant savings in metal cost and weight by eliminating the ICB assembly that is made of plastic and copper busbars. The subject disclosure has further weight savings by completely removing the bus bar material as well as the structure required to support the busbars in the correct position for tab attachment. The cost savings is also significant as the amount of copper and plastic for the ICB is completely eliminated.

Additional benefits include the following. The array and pack energy density is increased. Further, the array is easier to manufacture. The direct tab-to-tab welds are more efficient as the weld thickness is reduced. The tabs are also easier to press directly onto each other, which reduces porosity and other welding issues. The manufacturing process is also more open to automated processing as it is no longer necessary to thread the cell tabs through the ICB prior to welding. It is also easier to meet creepage and clearance requirements because there are less components to package, and the connection is more reliable as there are fewer parts and connection interfaces.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A method, comprising:
(a) laying battery cells next to each other such that at least one cell tab from one battery cell overlaps at least one cell tab from an adjacent battery cell;
(b) joining overlapping cell tabs directly to each other;
(c) placing the battery cells in a final assembly position; and
(d) installing voltage sense circuitry directly to the cell tabs.

2. The method according to claim 1, wherein step (c) includes folding the battery cells.

3. The method according to claim 1, wherein the one battery cell has a first cell tab comprising an aluminum material and the adjacent battery cell has a second cell tab comprising a copper material, and including placing the first cell tab over the second cell tab such that the first cell tab directly faces a laser weld tool.

4. The method according to claim 1, wherein step (b) includes one of the following joining methods: ultrasonic welding, laser welding, fastening, riveting, or adhering.

5. The method according to claim 1, wherein the battery cells include at least one first battery cell and at least one second battery cell, and including laying the at least one second battery cell next to the at least one first battery cell such that the cell tabs of the at least one first and second cells overlap each other.

6. The method according to claim 5, wherein the at least one first battery cell comprises a plurality of first battery cells stacked on top of each other to form a first cell stack, and wherein the at least one second battery cell comprises a plurality of second battery cells stacked on top of each other to form a second cell stack, and including laying the second cell stack next to the first cell stack such that the cell tabs of the first and second cell stacks overlap each other.

7. The method according to claim 1, further including:
(e) installing the battery cells into an array, and
(f) connecting a cable to cell terminals of the battery cells to connect the array to a pack wiring harness or sensor module.

8. The method according to claim 1, wherein step (d) includes directly connecting the voltage sense circuitry to the cell tabs using ultrasonic welding.

9. The method according to claim 1, wherein step (d) includes directly connecting the voltage sense circuitry to the cell tabs using electrically conductive rivets.

10. A method, comprising:
(a) laying battery cells next to each other such that at least one cell tab from one battery cell overlaps at least one cell tab from an adjacent battery cell;
(b) joining overlapping cell tabs directly to each other;
(c) folding the battery cells in a final assembly position; and
(d) installing a voltage sense circuitry directly to the cell tabs.

11. The method according to claim 10, wherein step (b) includes laser welding, ultrasonic welding, fastening, riveting, or adhering the cell tabs to each other.

12. The method according to claim 10, wherein the battery cells include at least one first battery cell and at least one second battery cell, and including laying the at least one second battery cell next to the at least one first battery cell such that the cell tabs of the at least one first and second cells overlap each other.

13. The method according to claim 10, wherein the at least one first battery cell comprises a plurality of first battery cells stacked on top of each other to form a first cell stack, and wherein the at least one second battery cell comprises a plurality of second battery cells stacked on top of each other to form a second cell stack, and including laying the second cell stack next to the first cell stack such that the cell tabs of the first and second cell stacks overlap each other.

14. The method according to claim 10, including:
(e) installing the battery cells into an array, and
(f) connecting a cable to cell terminals of the battery cells to connect the array to a pack wiring harness or sensor module.

15. The method according to claim 10, wherein step (d) includes directly connecting the voltage sense circuitry to the cell tabs using ultrasonic welding.

16. The method according to claim 10, wherein step (d) includes directly connecting voltage sense circuitry to the cell tabs using electrically conductive rivets.

17. An apparatus, comprising:
a plurality of battery cells laid next to each other such that cell tabs from one battery cell overlap cell tabs from an adjacent battery cell to form a set of overlapped cell tabs, and wherein each set of overlapped cell tabs are directly joined to each other at a connection interface; and
a voltage sense circuitry that is directly attached to the cell tabs.

18. The apparatus according to claim 17, wherein the battery cells include at least one first battery cell and at least one second battery cell, and wherein the at least one second battery cell is laid next to the at least one first battery cell such that the cell tabs of the at least one first and second cells overlap each other prior to joining the cell tabs to each other.

19. The method according to claim 18, wherein the at least one first battery cell comprises a plurality of first battery cells stacked on top of each other to form a first cell stack, and wherein the at least one second battery cell comprises a plurality of second battery cells stacked on top of each other to form a second cell stack, and wherein the second cell stack is laid next to the first cell stack such that the cell tabs of the first and second cell stacks overlap each other prior to joining the cell tabs to each other.

20. The apparatus according to claim 17, wherein the battery cells are positioned within an array, and including a cable connected to cell terminals of the battery cells to connect the array to a pack wiring harness or sensor module.
